(19) United States
(12) Patent Application Publication
(10) Pub. No.: US 2009/0104090 A1
(43) Pub. Date: Apr. 23, 2009

(54) IN-SITU DIFFUSION ALLOYING AND PRE-OXIDATION ANNEALING IN AIR OF FE-CR-AL ALLOY CATALYTIC CONVERTER MATERIAL

(76) Inventors: Lichun Leigh Chen, Walpole, MA (US); Bijendra Jha, Attlebore, MA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/327,535

(22) Filed: Dec. 3, 2008

Related U.S. Application Data
(63) Continuation of application No. 10/807,792, filed on Mar. 24, 2004.
(60) Provisional application No. 60/493,168, filed on Aug. 7, 2003.
(60) Provisional application No. 60/457,079, filed on Mar. 24, 2003.

(51) Int. Cl. B01D 53/34; B21D 51/16; B32B 3/12

(52) U.S. Cl. 422/177; 29/890; 428/116

(57) ABSTRACT

A manufacturing method of metal substrate catalytic converter and the resulting product. In this method, a multiple layer aluminum and ferritic stainless steel composite material is first made by roll-bonding and then further processed to a final foil thickness. The composite foils are then fabricated to a honeycomb-like converter with air flow channels. The converter is then thermally treated at a high temperature during a necessary converter fabrication process. The monolithic FeCrAl alloy is then obtained in the converter by in-situ diffusion alloying with pre-oxide film on the surfaces. The resulted material has improved oxidation resistance and thermal dimension stability at a high temperature.

### RELATED APPLICATIONS

This application is based upon and claims the benefit of priority from U.S. application Ser. No. 10/807,792 filed on Mar. 24, 2004, which is based upon and claims the benefit of priority from U.S. Provisional Application No. 60/493,168 filed on Aug. 7, 2003, and U.S. Provisional Application No. 60/457,079 filed on Mar. 24, 2003, the contents of which are all expressly incorporated herein by reference.

### TECHNICAL FIELD

This present invention is directed to a product and method of producing the product wherein the product is useful in the production of catalytic converters. More specifically, this application relates to in-situ diffusion alloying and pre-oxidation annealing, in air, of an FeCrAl alloy which is particularly useful in catalytic converters.

### BACKGROUND OF THE INVENTION

This invention provides a method for the manufacturing of a metallic catalytic converter material having corrosion resistance and thermal dimension stability at high temperatures. More particularly, a method for producing a metal foil material by a process of annealing of in-situ diffusion alloying and pre-oxidation in air during a catalytic converter production process is provided.

As well known, exhaust gases discharged from motor vehicles may contain halogen gases, halogen compounds and lead compounds, for example, Cl₂, Br₂, PbCl₂, C₂H₂Cl₂, C₂H₂Br₂, etc., besides un-burnt noxious gases including carbon monoxide, hydrocarbon and the like, and components or parts made of ferrous base alloy material for exhaust system of the motor vehicles or the like, for example, heat exchangers, air ducts, containers, etc., tend to be subjected to corrosion by the noxious compounds as described above. Moreover, halogen compounds (e.g. salt) employed for preventing freezing during cold seasons are liable to enter these components of ferrous base alloy material, which are then corroded by the atmosphere containing halogen gas produced when the halogen compounds are decomposed at high temperatures.

It has been known to use metal foil materials as substrates with an appropriate catalyst coating in place of traditional ceramic material substrates. Such metal foil materials have been made in the past by ingot metallurgy from steel sheets containing aluminum and also chromium, thereby forming FeCrAl alloys, in order to have the desired corrosion resistance at high temperatures which exist in catalytic converters. These FeCrAl alloys, however, are difficult to produce by conventional rolling and annealing processes. To overcome the processing difficulties, it has been suggested, as in EP application 91115501.8, to produce the foil by a rapid solidification processing method; but such processing is expensive and requires very precise controls. It has also been suggested to dip the stainless steel in a molten bath of aluminum or aluminum alloy to apply melt-plating on the surface of the stainless steel (U.S. Pat. Nos. 3,907,611, 3,394,659 and 4,079,157). This stainless steel with the aluminum is then subjected to a heat treatment to form an alloy layer having Fe and Al as the main components. Still further, surface layers of aluminum in binder materials, as described in U.S. Pat. No. 4,228,203, have also been suggested. However, in all of these applications the control of the processing parameters is complex and expensive. Further the final foil has not proven, in many cases, to have the desired corrosion/oxidation resistance at elevated temperatures required in the catalytic converter industry.

Still another approach is to manufacture the catalytic converter substrate material by using a metallurgically bonded composite material with layers of ferritic stainless steel and aluminum as described in U.S. Pat. No. 5,366,139 owned by the assignee of this instant application. This substrate material has proven to be very useful, but any in-situ diffusion process would need to be performed in a vacuum. Further the oxidation resistance and dimension stability for such materials has not been reported. In U.S. Pat. No. 5,447,698, aluminum oxide on the surfaces of the material produced was obtained during a separate heat treatment process, in air, following an in-situ process in vacuum. Still, no data of oxidation resistance and dimension stability performance were reported.

Meanwhile, pre-oxidation of FeCrAl ferritic stainless steel was used in a separate process to increase oxidation resistance at high temperature for the same application in catalytic converter by some researchers. The oxide film formed during pre-oxidation provided higher resistance to the oxidation than those without the treatment.

The Fe—Cr—Al alloy foil currently used in catalytic converters used for emission control has been made by roll-bonding and in-situ diffusion annealing in vacuum, as described in the previous U.S. patents. The oxidation performance of the Fe—Cr—Al alloy foil can be improved by pre-oxidation during annealing of cold-rolled Fe—Cr—RE alloy foil demonstrated by different researchers.

### SUMMARY OF THE INVENTION

Accordingly, the present invention provides for a method to manufacture ferritic metal foil, such as that made from roll-bonding and typically utilized in catalytic converters, with high oxidation resistance and dimension stability at high temperatures in an exhaust gas atmosphere. Further, a pre-oxidized surface film containing Al oxides is produced which has good adhesion upon being subject to catalytic wash coating. In addition, the final material is easily and economically manufactured for high volume applications.

This invention involves using in-situ alloying diffusion and pre-oxidation annealing in air to make a catalytic converter for air emission control having good properties such as oxidation resistance and dimension stability at the high temperatures typically present in catalytic converters. In brief, an Fe-20Cr alloy is roll-bonded with commercially pure aluminum to form an Al/Fe-20Cr/Al sandwich composite alloy. The Al/Fe-20Cr/Al composite alloy is then rolled to a finish foil thickness. The finish thickness foil then is processed to an appropriate width and surface cleanness for making a metal substrate catalytic converter. More specifically, during the production of catalytic converters, a piece of the Al/Fe-20Cr/Al alloy finish thickness foil is corrugated and then wound or stacked with a flat foil to obtain a honeycomb-like converter with channels for air flow. A certain approach of restrain is used to make mechanical restraining in the honeycomb-like converter. Similar honeycomb-like oxidation testing sample converters, in a smaller size, can be made in the same way. The Al/Fe-20Cr/Al honeycomb-like converter is then placed into a furnace which has already been heated to a stable temperature of between about 800° C. to about 1200° C. for annealing in air. After a period of time sufficient to allow for diffusion of the Al into the Fe-20Cr layer, the converters are cooled down. The resulting converters then were completed, wherein aluminum in the Al/Fe-20Cr/Al sandwich composite foil has now diffused into the Fe-20Cr base thereby forming a monolithic Fe-20Cr-6% Al alloy foil having pre-oxidized surfaces.

The pre-oxidized film on surface of the monolithic Fe-20Cr-6% Al alloy foil comprises aluminum oxides dominated with good adhesion on the surfaces. The samples prepared according to the invention do not have evidence of oxidation film separation before and after oxidation testing by mechanical stirring in an ultrasonic cleaner containing the solutions in which the samples are submerged. The oxidation resistance (weight gain) and dimension stability showed good performance during semi-cyclic oxidation testing at 1100° C. and 800° C. If oxidation resistance and dimension stability were negatively affected, in some instances, by undesirable trace residuals, the said properties of the resulted converters are still better than those of the material in-situ diffusion alloyed in vacuum without pre-oxidation at finish thickness and the material diffusion-alloyed in vacuum at higher thickness than finish thickness followed by cold-rolling and annealing in vacuum.

In accordance with the one aspect of the novel and improved method and material of this invention, a first central layer 10 of ferrous material is sandwiched between two outer layers 12 and 14 of aluminum or aluminum alloy material. The three layers are passed between a pair of pressure rolls 16 in a conventional rolling mill 18. The layers are squeezed together with sufficient force to be reduced in thickness, and metallurgically bonded together along interfaces 20 and 22 between the metal layers to form a multilayer composite metal material 24 as shown in FIG. 2. The multilayer composite material is then continuously rolled to the finished desired foil thickness. The finish thickness foil then is processed to an appropriate width and surface cleanness for making metal substrate catalytic converters. In preparing the metal substrate catalytic converters, a piece of the finish thickness foil is corrugated and then wound or stacked with a flat foil to obtain a honeycomb-like converter with channels for air flow through. A certain approach of restraint is used to make mechanical restraining in the honeycomb-like converter. The honeycomb-like converter was then placed into a furnace which is already at a stable temperature of between about 800° C. to about 1200° C. for annealing in air. After a period of time which is sufficient to allow for diffusion of the Al into the Fe—Cr layer, the converters are cooled down with the furnace.

The resulting converters are a finished product having aluminum in the multilayer composite material which has already diffused into the Fe—Cr to form a monolithic FeCrAl alloy with pre-oxidized foil surfaces. That is the in-situ diffusion alloying and pre-oxidation in the material of the catalytic converter are obtained in a single process after a honeycomb-like catalytic converter is made. Since the thermal treatment is needed during catalytic converter manufacturing, the method of the invention provides a cost effective process in the manufacture of catalytic converters. As a result of the novel process of the present invention, the material used in the catalytic converters has improved dimensional stability with proper surface morphology for good catalysis washing coating adhesion.

These and other aspects of the invention are set forth below in the detailed description and in the drawings.

### BRIEF DESCRIPTION OF THE DRAWINGS

Other objects, advantages and details of the novel material and method of manufacture of this invention appear in the detailed description of the preferred embodiments of the inventions, the detailed description referring to the drawings in which:

FIG. 1 shows a side elevation view diagrammatically illustrating the bonding method of this invention.

FIG. 2 shows the composite material of this invention after bonding.

FIG. 3 diagrammatically shows the material of this invention after diffusion heat treatment.

FIG. 4 diagrammatically shows the resulted material in a catalytic converter.

FIG. 5 shows a photomicrograph of the resulted material in a catalytic converter of FIG. 3.

FIG. 6 Surface of the resulted material in the catalytic converter.

FIG. 7 Oxidation weight gain of the resulted material showing oxidation resistant at 800° C. temperature.

FIG. 8 Length change of specimens tested at high temperature showing dimension stability at 800° C. temperature.

FIG. 9 Oxidation Weight Gain of the resulted material showing oxidation resistant at 1100° C. temperature.

FIG. 10 Length change of specimens tested at high temperature showing dimension stability at 1100° C. temperature.

### DETAILED DESCRIPTION OF THE PREFERRED EMBODIMENTS

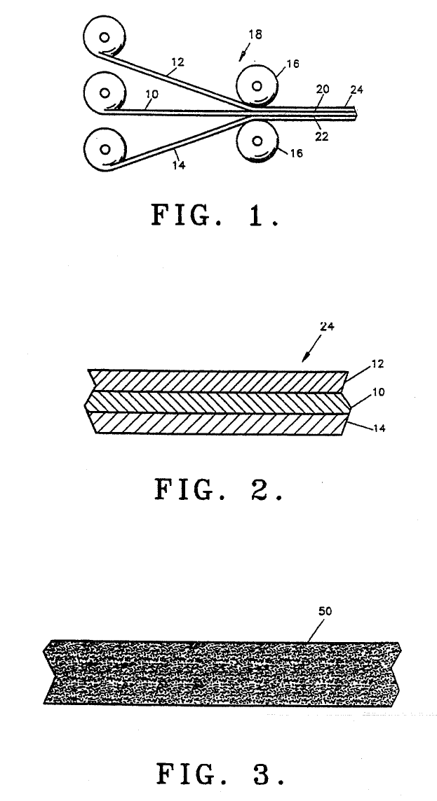

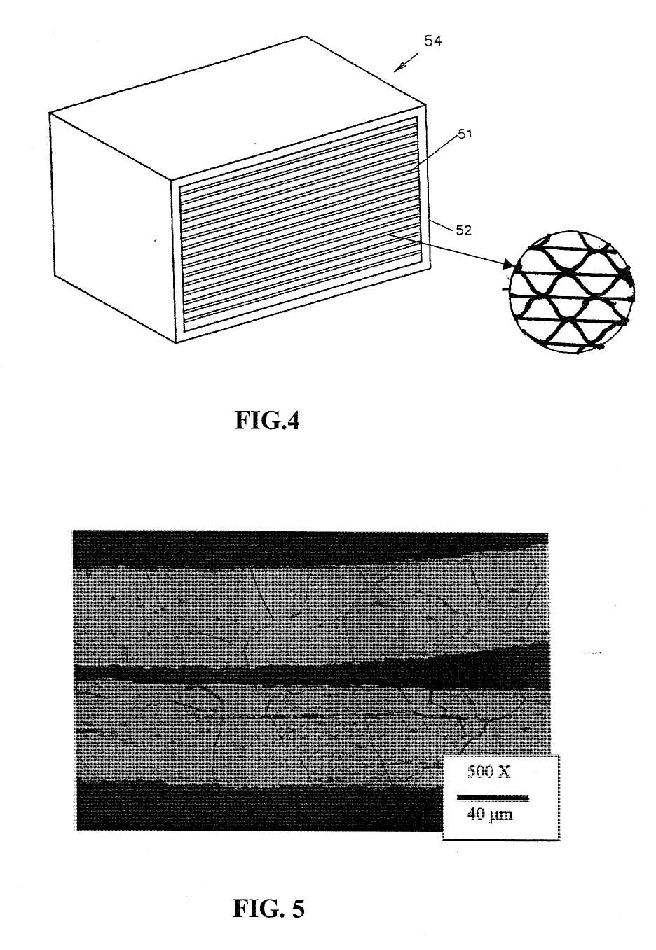

In accordance with the novel and improved method and material of this invention, a first central layer 10 is sandwiched between two outer layers 12 and 14 of typically the same material. The three layers are passed between a pair of pressure rolls 16 in a conventional rolling mill 18. The layers are squeezed together with sufficient force to be reduced in thickness and metallurgically bonded together along interfaces 20 and 22 between the metal layers wherein a composite multilayer metal material 24 is formed as shown in FIG. 2. The material is then rolled to the finished desired foil thickness. The material is then further processed to a desirable width and appropriate cleanliness. The finish thickness and width foil composite material is then used for making a metal substrate catalytic converter. To make the metal substrate catalytic converter, pieces of the finish thickness foil are corrugated and then wound or stacked with a flat foil to obtain a honeycomb-like converter body with channels for air flow as showed in FIG. 4. A certain approach of restrain, such as welding and mechanical clamping, is used to make restraining on the honeycomb-like converter. The converter, and hence the material that it is made of, is then thermally treated as will be explained in detail below.

Typically, the first layer 10 comprises a ferritic stainless steel with about 16 to 24 wt. % Cr, and the balance Fe with the S content less than 0.003 wt. %. Examples of such ferritic stainless steels are 430, 434 and 446 stainless steels with controlled sulfur content. Preferably, top and bottom layers 12 and 14 are of the same thickness and material, and are comprised of essentially pure aluminum although aluminum alloys could also be used.

It is understood that the invention could equally well be practiced with a central relatively thinner layer of aluminum or aluminum alloys, and top and bottom layer of the ferritic stainless steel material or other layered structure. Also, other materials could be substituted for the named materials, such as nickel alloys, in place of the ferritic stainless steel materials.

In a preferred embodiment having excellent high temperature corrosion resistance, it has been found desirable to have a final chemistry in the final material 50 after thermal reaction (to be explained in detail below) of between about 18 to about 21 wt. % Cr, at least about 5 wt. % Al and the balance Fe. Additionally, small amounts of Hf, Y and/or rare earth metals such as La, Ce, Pr, etc. can be added to either of the metals forming the composite to also increase high temperature corrosion resistance. An example of such an embodiment is where a layer of 434 stainless steel, having a thickness typically of between 0.045 and 0.075 of an inch, is bonded to essentially pure aluminum top and bottom layers having a thickness typically of between about 0.004 and 0.008 of an inch thereby yielding a bonded composite of approximately 0.015 to 0.040 of an inch as shown in FIG. 3. One typical example results in a composite of about 84% stainless steel and a top and bottom layer of aluminum of about 8% each. The initial starting thicknesses of the layers have been chosen to determine the ultimate chemistry of the final composite after thermal reaction.

Accordingly, the honeycomb-like catalytic converter, and thus the composite material that the converter is made from, is placed into the conventional electric heat treating furnace in air at a temperature between about 900° C. to about 1200° C., and preferably at between about 950° C. to about 1050° C., and held for between about 10 and about 60 minutes or longer, for internal reaction or diffusion heat treatment to provide for diffusion of the various constituents in the composite throughout the foil material in the converter, as well as to provide for pre-oxidation to obtain aluminum oxide film on the material surfaces in a single process. That is, after this heat treating operation, the microstructure of the foil material will not be a three-layer structure but instead be a uniform solid solution alloy with thin protective aluminum oxide film on the surface. It is important that the converter, and thus the composite material, will be heated at very fast rate to reach the temperature stated, with a desire that a diffusion of aluminum of the out layer into the center layer of steel base occurs and thin protective alpha phase aluminum oxide film forms, before outside layer aluminum depletes for reaction with oxygen in the air by oxidation. Therefore, it is desirable that the furnace should have already reached a temperature stated above before the converter and thus the composite material that it is made from, is placed for the heat treatment. Alternatively, the furnace should reach the minimum temperature for aluminum to diffuse into the steel base, e.g., be well above the melting point of aluminum or aluminum alloy, before the converter and thus the composite material that it made from, is placed in the furnace and the temperature should then quickly rise to about 900° C. to about 1200° C. as stated above after the converter is in the furnace for the heat treatment. It is important that the heating be for sufficient time to dissolve any formed intermetallic compounds, preferably at a temperature to not allow for the formation of a brittle sigma phase of CrFe or other brittle compounds.

In order to give appreciation of the advantages of the invention, the following examples are given:

### Example I Comparative

A continuous strip of annealed stainless steel of the following composition:
22 wt % Cr,
0.7 wt % Al,
0.02 wt % Ce,
0.008 wt % La,
0.035 wt W C,
0.027 wt % N,
<0.002 wt % S
0.33 wt % Si
0.21 wt % Mn
balance Fe with an unavoidable trace amount of impurities, was sandwiched between two continuous strips of Al foil in a single operation to yield a solid state metallurgically bonded three layer composite.

This part of the process is as described in U.S. Pat. No. 5,366,139 which is incorporated herein by reference. This continuous strip was cold rolled on a conventional rolling mill in multiple passes until the final gauge of about 0.002 inches was achieved. This foil material was then cleaned, processed to a final proper width, and made into honeycomb-like converter samples. The honeycomb-like converter samples were heated to about 1100° C. in a vacuum for about 30 minutes to diffuse all the aluminum into the stainless steel base, thereby forming a completely homogeneous solid solution alloy foil material in the honeycomb-like body. The foil thus produced shows a nominal chemical composition of
21 wt % Cr and
6 wt % Al.
0.02 wt % Ce
0.007 wt % La
0.035 wt % C
Balance Fe with an unavoidable trace amount of impurities.

Semi-cyclic oxidation testing was performed on the honeycomb-like roll converter testing samples with a cell density of approximately 400 cells per square inch. The samples were heated from room temperature to the testing temperature in about 2 hours and held for a period of time and then cooled down to room temperature in about 6 hours. The holding time of a cycle was about 5 hours, 20 hours, 25 hours, 50 hours, 50 hours, . . . , 50 hours, until total accumulated time reached about 400 hours. The weight gain due to oxidation and length change between two ends of the honeycomb-like roll testing sample were measured at the end of each cycle.

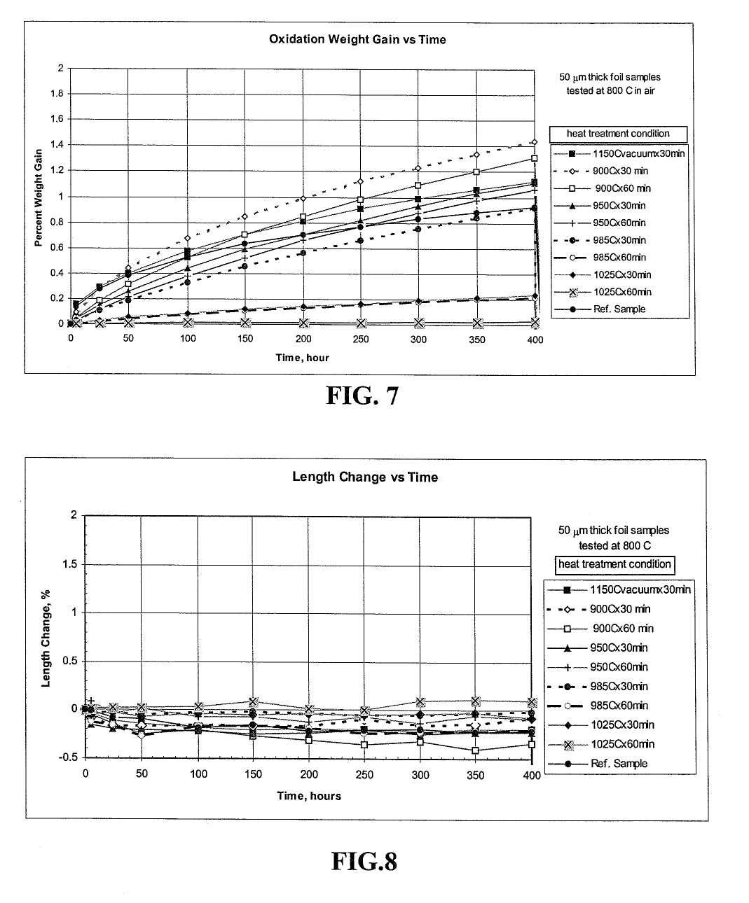

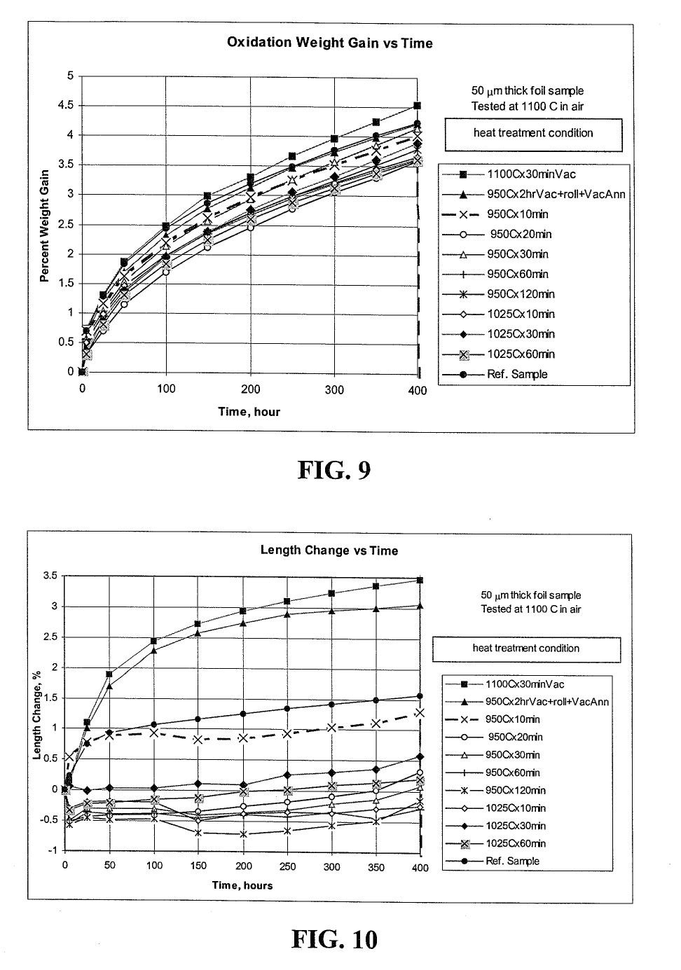

The weight gain percentage and length change of the honeycomb samples are very good at about 800° C. in air as showed in FIGS. 7 and 8. However, the weight gain percentage and length change percentage increased significantly when the samples tested at about 1100° C. in air as Showed FIGS. 9 and 10. Particularly, the length change percentage, an indication of dimension stability, is above an acceptable criteria of catalytic converter application in automobile engines. One of the criteria in maximum length change is 2%. The weight gain and length change data after about 400 accumulated hour testing at about 800° C. and about 1100° C. are also listed in Table 1 below.

| | 800 C. × 400 hr. Test | | | 1100 C. × 400 hr. Test | | |
|---|---|---|---|---|---|---|
| | Oxidation | | Length | Oxidation | | Length |
| | Weight Gain | | Change | Weight Gain | | Change |
| | % | g/mm2 | % | % | g/mm2 | % |
| 0.002, 1100 C. × | 1.13 | 1.99 | −0.20 | 4.54 | 8.00 | 3.47 |
| 30 min., in vacuum | | | | | | |

### Example II Comparative

This example was carried out identical to Example I except that the cold rolling of composite material strip was terminated at about 0.004 inches. This strip was then heated up to at about 950° C. with the furnace and hold for about 120 minutes in a vacuum to produce the fully homogeneous solid solution strip. This homogeneous alloy strip was then cold rolled to about 0.002 inches in a conventional rolling mill. The material has the same nominal alloy chemistry as in Example I. The finished foil was then made into a honeycomb-like roll catalytic converter testing sample after cleaning and was annealed at about 1100° C. for about 30 minutes in a vacuum. The testing was performed as described in Example I to obtain oxidation weight gain and length change. The results were showed in the same Figures as in Example I and also listed in the following Table 2.

1100 C. × 400 hours Test

| | |
|---|---|
| Oxidation | Length |
| Weight Gain | Change |

| Process | % | g/mm2 | % |
|---|---|---|---|
| 0.004″, 950 C. × 120 min. in | 4.15 | 7.31 | 3.06 |
| vacuum; then roll to 9.002″; | | | |
| plus 1100 C. × 30 min. in vacuum | | | |

It can be seen that the oxidation resistance (oxidation weight gain) and dimension stability (length change percentage) at about 1100° C. have been improved, compared to Example I. However, the length change is still too high to meet the criteria needed for catalytic converters to be used in automobile engines.

The unfavorable high length change of Examples I and II, compared with data of the reference material (as showed in Table 3, made in the same way described in this example) is believed due at least partially to its higher carbon (C) percentage, La amount at a marginally acceptable lower level, and other unfavorable unanalyzed impurities. The material with such alloy chemistry was chosen to test whether the current novel process method would improve the performance of the catalytic converter materials as described below. The reference materials had a nominal chemical composition of
21 wt % Cr
6 wt % Al.,
0.02 wt % Ce,
0.010 wt % La,
0.013 wt % C
balance Fe with an unavoidable trace amount of impurities.

| | 800 C. × 400 hr. Test | | | 1100 C. × 400 hr. Test | | |
|---|---|---|---|---|---|---|
| | Oxidation | | Length | Oxidation | | Length |
| | Weight Gain | | Change | Weight Gain | | Change |
| | % | g/mm2 | % | % | g/mm2 | % |
| Reference | 0.93 | 1.63 | −0.22 | 4.25 | 7.49 | 1.52 |
| Material | | | | | | |

### Example III

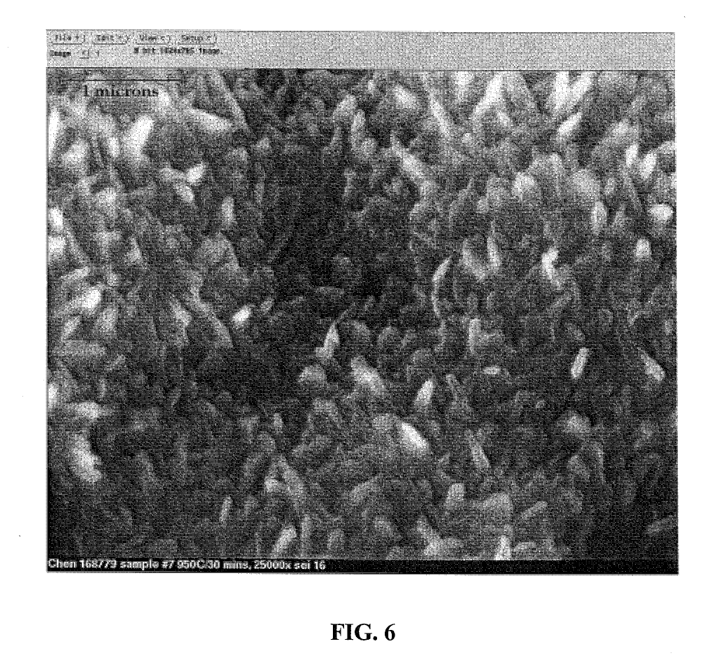

This example was carried out identical to Example I except that the heat treatment was performed differently. The honeycomb-like converter samples were made from the foil composite material at a thickness of about 0.002 inches, as described in Example I. These honeycomb-like samples were placed directly into a furnace which was already at a holding temperature of between about 900° C. to about 1150° C., which was well above the aluminum melting point and at alpha alumina formation temperature range, holding for different times from about 10 minutes to about 120 minutes, and then cooled down with the furnace. The heat treatments were performed in the atmosphere of air instead of in vacuum condition. The details of the different heat treatment schedules is listed in Table 4 below. After the heat treatments, the composite material foil in the honeycomb-like converter samples became homogenous as showed in FIG. 5, while an alumina film was formed on the surfaces of the material as shown in FIG. 6. That is, the in-situ diffusion alloying and pre-oxidation occurred in the foil material of the converter in a single process during the treat treatment in air. After the heat treatments, the same nominal alloy chemical composition was obtained as in Example I.

Most importantly, the oxidation resistance and dimension stability have been meaningfully improved at the testing temperature of about 1100° C. as shown in FIGS. 8 and 10. The length of change percentage of the testing samples are all below the minimum required criteria for catalytic converters which are to be used in automobile engines. The weight gain and length change data after total 400 accumulated hours testing at about 800° C. and about 1000° C. are listed in Table 4 below.

| | 800 C. × 400 hr. Test | | | 1100 C. × 400 hr. Test | | |
|---|---|---|---|---|---|---|
| | Oxidation | | Length | Oxidation | | Length |
| | Weight Gain | | Change | Weight Gain | | Change |
| | % | g/mm2 | % | % | g/mm2 | % |
| 0.002″, 900° C. × | 1.44 | 2.54 | −0.08 | | | |
| 30 min in air | | | | | | |
| 0.002″, 900° C. × | 1.31 | 2.31 | −0.34 | | | |
| 60 min in air | | | | | | |
| 0.002″, 950° C. × | | | | 4.02 | 7.09 | 1.29 |
| 10 min in air | | | | | | |
| 0.002″, 950° C. × | | | | 3.59 | 6.33 | 0.33 |
| 20 min in air | | | | | | |
| 0.002″, 950° C. × | 1.11 | 1.96 | −0.23 | 4.15 | 7.31 | 0.09 |
| 30 min in air | | | | | | |
| 0.002″, 950° C. × | 1.06 | 1.87 | −0.09 | 3.63 | 6.40 | −0.29 |
| 60 min in air | | | | | | |
| 0.002″, 950° C. × | | | | 3.79 | 6.68 | −0.15 |
| 120 min in air | | | | | | |
| 0.002″, 985° C. × | 0.92 | 1.62 | −0.02 | | | |
| 30 min in air | | | | | | |
| 0.002″, 985° C. × | 0.22 | 0.39 | −0.21 | | | |
| 60 min in air | | | | | | |
| 0.002″, 1025° C. × | | | | 3.66 | 6.45 | −0.24 |
| 10 min in air | | | | | | |
| 0.002″, 1025° C. × | 0.23 | 0.41 | −0.08 | 3.89 | 6.89 | 0.59 |
| 30 min in air | | | | | | |
| 0.002″, 1025° C. × | 0.03 | 0.05 | 0.10 | 3.61 | 6.36 | 0.20 |
| 60 min in air | | | | | | |

The pre-oxidized film formed on the surface of the honeycomb-like catalytic converter after heat treatments consists of aluminum oxide dominated with good adhesion on the surfaces. There was no evidence of oxidation film separation from the base alloy before and after oxidation testing after mechanical stirring in an ultrasonic cleaner which contained the solutions in which the samples are submerged.

### Example IV

This example was carried out identical to Example III except the heat treatment schedule was different. The honeycomb-like catalytic converter roll samples were placed into a conventional heat treating electric furnace which had already reached a temperature of about 720° C. and was then heated to a temperature of about 980° C. within approximately 30 minutes and held for about 2 hours followed by furnace cooling. The treated converter samples were then coated by catalysis wash coating. The special tests showed that the adhesion between catalysis wash coating and pre-oxide surfaces of materials in the catalytic converter samples were strong and acceptable from the industrial standard.

The novel process and article produced by method of the present invention provides for a foil material which can be used in catalytic converters, wherein the foil material exhibits improved corrosion resistance at elevated temperatures, improved thermal dimension stability, and excellent surface characteristics for adhesion of catalysis wash coating. The chemical composition is uniform throughout the foil sheet which has a pre-oxidation film on the surfaces thereof. It can be easily and economically used in manufacturing catalytic converters as the in-situ diffusion alloying and pre-oxidation heat treatment in a single process can be accommodated into an existing catalytic converter heat treatment production process. While the invention has been described in combination with the specific embodiments thereof, it is evident that many alternatives, modifications and variations will be apparent to those skilled in the art in light of a foregoing description.

The invention has been described hereinabove using specific examples. However, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A method for preparing a honeycomb-like structure having oxidation resistance and dimensional stability, comprising the steps of:
a) sandwiching a first layer of the first material between two layers of a second material to produce a multilayer composite;
b) compaction rolling the composite to a finished foil;
c) processing the finished foil with a flat foil into the honeycomb-like structure having channels for air flow;
d) heating the honeycomb-like structure in an air atmosphere at an annealing temperature so to produce a monolithic honeycomb-like annealed alloy foil structure with a pre-oxidized surface; and
e) cooling the structure to room temperature.

2. The method as claimed in claim 1, wherein the first metal material or the second metal material contains iron.

3. The method as claimed in claim 1, the first layer is an iron chromium material.

4. The method as claimed in claim 1, wherein the first layer is a Fe—Cr Alloy.

5. The method as claimed in claim 1, wherein the second material is aluminum.

6. The method as claimed in claim 1, wherein the second material is an aluminum alloy.

7. The method as claimed in claim 1, wherein the first material is selected from the group consisting of stainless steel 430, 434 and 446.

8. The material as claimed in claim 5, wherein the pre-oxidized surface is aluminum oxide.

9. The honeycomb-like structure prepared according to claim 1.

10. A method for preparing a honeycomb-like structure having oxidation resistance and dimensional stability, comprising the steps of:
a) providing a first layer of a Fe—Cr alloy material;
b) sandwiching the first layer between at least two layers of aluminum or an aluminum alloy to produce a multilayer composite;
c) compacting the composite to a finished thickness metal composite foil;
d) processing the finished thickness metal composite foil the honeycomb-like structure having channels for air flow;
e) heating the honeycomb-like structure in an air atmosphere at an annealing temperature so to produce a monolithic honeycomb-like annealed alloy foil structure with a pre-oxidized surface; and
f) cooling the monolithic honeycomb-like annealed alloy foil structure to room temperature.

11. The method of claim 10, wherein the Cr content in the first layer is about 16 wt % to about 24 wt %.

12. The method of claim 10, wherein the Cr content is about 16 wt % to about 24 wt %.

13. The method of claim 10, wherein the first metal material is selected from stainless steel 430, 434 and 446.

14. The method of claim 10, wherein the annealing temperature is from about 900° C. to about 1,200° C.

15. The method of claim 10, wherein the period of time for heating is between about 10 minutes and about 120 minutes.

16. The method of claim 10, wherein the pre-oxidized surface is aluminum oxide.

17. A product produced in accordance with the process of claim.

18. A catalytic converter comprising a product produced according to the process of claim 11.

19. A process of making a ferrous metal catalytic substrate for a catalytic converter, comprising the steps of:
a) providing a first layer of a Fe—Cr alloy material;
b) sandwiching the first layer between at least two layers of aluminum or an aluminum alloy to produce a multilayer composite;
c) compacting the composite to a finished thickness metal composite foil;
d) processing the finished thickness metal composite foil the honeycomb-like structure having channels for air flow;
e) heating the honeycomb-like structure in an air atmosphere at an annealing temperature so to produce a monolithic honeycomb-like annealed alloy foil structure with a pre-oxidized surface; and
f) cooling the monolithic honeycomb-like annealed alloy foil structure to room temperature.

20. The process of claim 19, wherein the first material is FeCr and the second material is pure aluminum oxide.
